(19) United States
(12) Patent Application Publication
(10) Pub. No.: US 2010/0080003 A1
(43) Pub. Date: Apr. 1, 2010

(54) Radiating cold light polymer lamp structure

(76) Inventor: Han-Ming Lee, Hsin Chu City (TW)

Correspondence Address: LEE, HAN-MING, P.O. BOX 7-820, TAIPEI, TW

(21) Appl. No.: 12/286,065

(22) Filed: Sep. 29, 2008

(51) Int. Cl. F21V 29/00

(52) U.S. Cl. 362/294

(57) ABSTRACT

The present invention relates to a radiating cold light polymer lamp structure, comprising radiating caps, plates, stop pieces, conducting wires, I-shaped frame plates, positioning brackets and light-emitting devices, wherein the I-shaped frame plate is provided for the light-emitting devices arranged in sequence, a hole is provided on each of the two ends of the conducting plates for the semi-holes of the stop pieces to fit the conducting wires for positioning so that the light emitting chips achieve stable conductivity and the chip cup screw transfers the heat of the chips directly to diffuse heat via the radiating cap to diffuse the heat and reduce the temperature rapidly and extend the service life.

### BACKGROUND OF THE INVENTION

According to the structure of the fluorescent light, covers are provided on the two ends of the diameter of the light tube, with two conducting pin tubes inserted into the cover surfaces. The conducting pin tubes pass through the sockets on the two sides of the light tube box frame to input current into the diameter of the light tube. The positive and negative AC power of the conducting pin tubes on the two sides are used to cause the fluorescent particles inside the light tube to generate light and give play to the function of the fluorescent light as a light source. However, the process of this structure is labor intensive and output restricted with considerable service life of the fluorescent particles. In addition, the process does not conform to modern environment protection awareness and requires plenty of electricity. Hence, modern LED lights are born and bound to replace the traditional fluorescent lights.

### SUMMARY OF THE INVENTION

The primary purpose of the invention is to provide a radiating cold light polymer lamp structure, which in particular refers to one that comprises radiating caps, plates, stop pieces, conducting wires, I-shaped frame plates, positioning brackets and light-emitting devices to diffuse the heat and reduce the temperature rapidly and extend the service life.

The secondary purpose of this invention is to provide a radiating cold light polymer lamp structure, wherein the I-shaped frame plate is provided for the light-emitting devices arranged in sequence, a hole is provided on each of the two ends of the conducting plates for the semi-holes of the stop pieces to fit the conducting wires for positioning so that the lighting chips achieve stable conductivity.

Another purpose of the present invention is to provide a radiating cold light polymer lamp structure, wherein the chip cup screw transfers the heat of the chip directly to diffuse heat via the radiating cap so as to diffuse the heat and reduce the temperature rapidly.

One more purpose of the present invention is to provide a radiating cold light polymer lamp structure, wherein a hole is provided on each of the two ends of the two plates for the conducting wires to pass through and be attached to the two ends of the I-shaped frame plate so that the two conducting wires will not become loose or displaced.

### BRIEF DESCRIPTION OF THE DRAWINGS

FIG. 1 shows a composition schema of the present invention.

FIG. 2 shows a 3D drawing of the components of the present invention.

FIG. 3 shows a 3D drawing of the components of the light-emitting device.

FIG. 4 shows a relevant embodiment schema of the conducting plate trench walls of the present invention.

FIG. 5 shows a diagram of the rapid heat diffusion function of the radiating cap of the present invention.

### DELTAILED DESCRIPTION OF THE PREFERRED EMBODIMENT

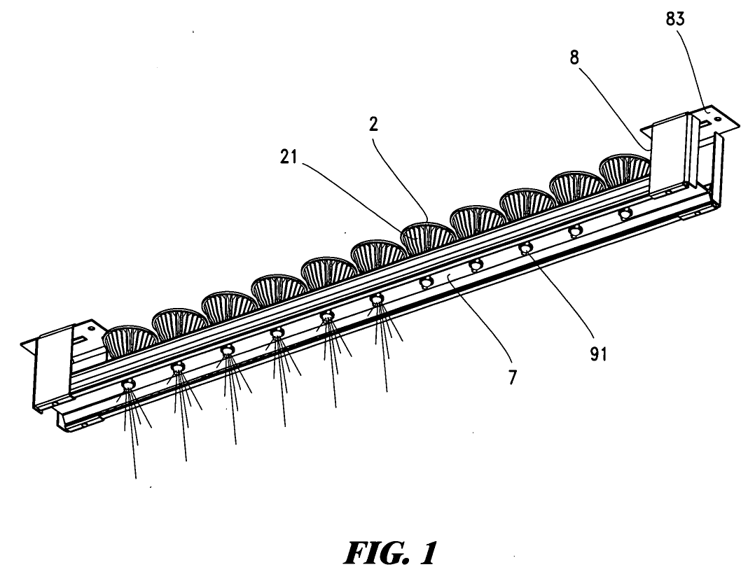

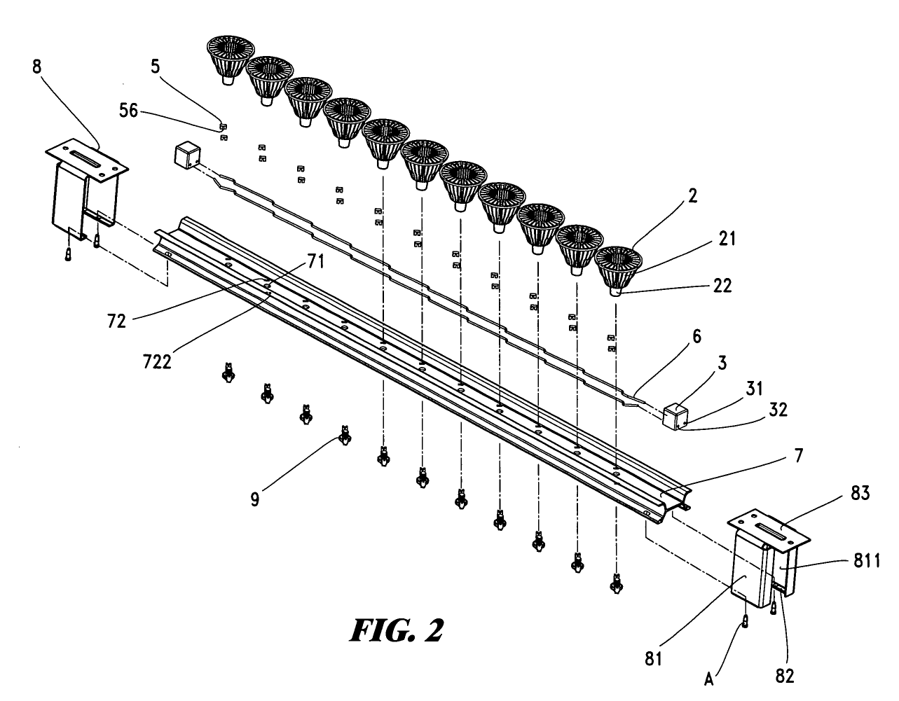

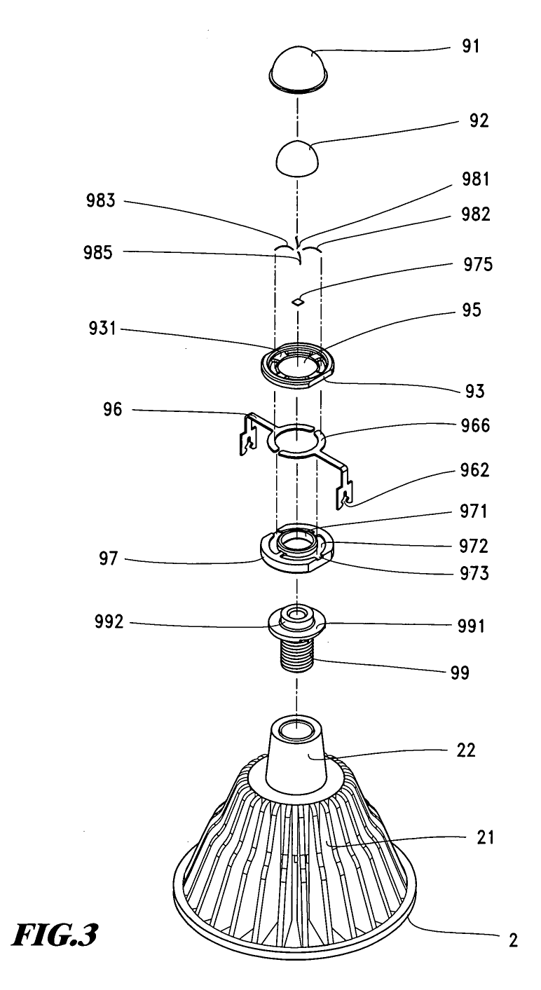

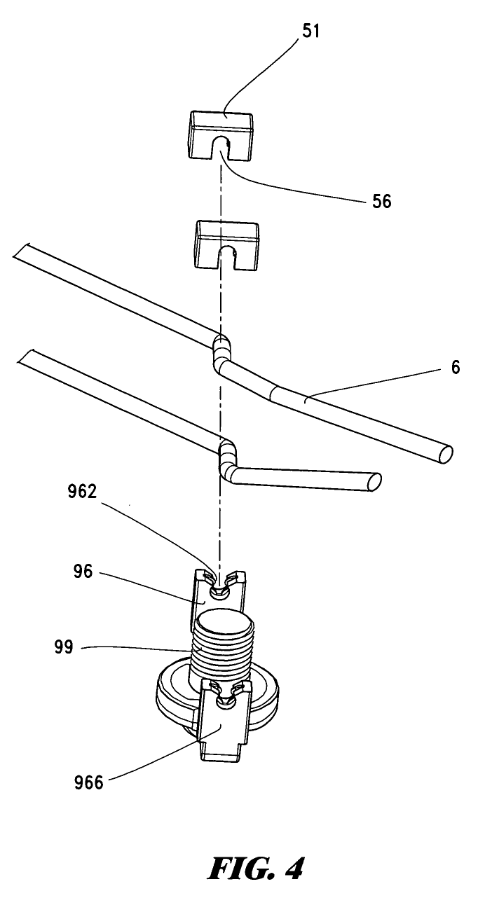

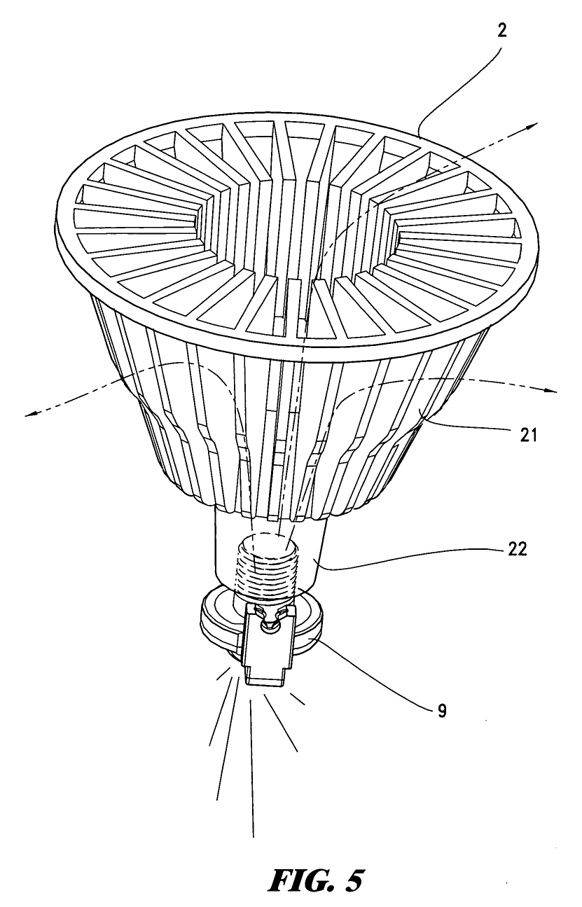

Referring to FIGS. 1 through FIGS. 5, the present invention relates to a radiating cold light polymer light structure, comprising Radiating Caps 2, two Plates 3, a plurality of Stop Pieces 5, two Conducting Wires 6, one I-shaped Frame Plate 7, two Positioning Brackets 8 and Light-emitting Devices 9; the said Radiating Cap 2 being a conical round, inside which are equally spaced Radiating Fins 21, the said conical diameter having a Screw Tube 22 at the top, the said screw tube having an internal female thread; the two Plates 3 being a square plate, the surface of which are provided with two Holes 31 and 32 near the bottom of the I-shaped Frame Plate; a plurality of Stop Pieces 5 being a hollow rectangle cover, on the two sides of which is a Semi-round Hole 56; the two Conducting Wires 6 are two conducting wires with two ends threaded through the holes of Plates 3; the I-shaped Frame Plate 7, being an I-shaped long strip plate having equally spaced Holes 71 on its surfaces, the holes having Rectangle Openings 72 and 722 placed nearby oppositely; in the two Positioning Brackets 8, the L-shaped frames 81 and 811 having bent Vertical Plates 82 in the lower part, the said two frames being welded with a Joining Plate 83 at the top for locking to the ceiling surface; the Light-emitting Device 9 comprising a Semi-round Lamp Housing 91, being a transparent semi-round lamp housing; a Transparent Silicone 92 is placed at the bottom of said Semi-round Lamp 91; the Upper Disk 93 having the Concave Ring 931 at the disk surface for the clamping and positioning of the ring seat of the Lamp Housing 91, the center of the said disk surface having an Axial Hole 95, the radial surface of the said concave ring having four equally spaced elliptical holes; the two Conducting Plates 96 and 966 being two Y-shaped conducting plates with the semi-round shape in the front, the bent vertical ends in the middle of the said two plates having Semi-round Holes 962 for the assembly of the Stop Pieces 5; the Lower Disk 97, being an integrated projected Hollow Bushing 971, the ring surface of the said disk having corresponding Semi-round Concave Groove 972 of the corresponding Conducting Plates 96 and 966 and the Concave Groove 973 of the Y-shaped plate for the insertion of the two Conducting Plates 96 and 966 so that the Axial Hole 95 of the Upper Disk 93 is fitted and integrated; a Light-emitting Semi-conductor Chip 975, the upper part of the said chip is provided for connecting the one end of the Conducting Wires 981, 982, 983, and 985, the other end of the conducting wires pass through the four elliptical holes of the upper disk and jump the semi-round conducting plates of the two conducting plates for the introduction of the power supply; the Chip Cup 99 being a heat transfer screw having a Gasket Ring 991 and a Pipe Shaft 992 at the top so that the Pipe Shaft 992 passes through the Hollow Shaft Bushing 971 of the pipe shaft for positioning, the male thread of the lower screw fits the screw tube of the Radiating Cap 22, the top of the said screw having a chip cup for the seating of the Chip 975; after the chip cup screws of Light-emitting Device 9 fit into the Holes 71, the two Conducting Plates 96 and 966 on the two sides of the screw pass through the Rectangle Openings 72 and 722 and the Semi-round Hole 962 clamps the two conducting wires and the Stop Piece 5, which is the main characteristics of the present invention.

In a successful embodiment of the present invention, the Pipe Shaft 992 at the top of the chip cup screw is inserted into the Hollow Shaft Bushing 971 of the lower disk for fixing; the two Conducting Plates 96 and 966 assemble Concave Groove 972 of the lower disk with the end of the Y-shaped semi-round front and press against the two sides of the screw in the shape of the two bent vertical plates; the Upper Disk 93 covers the lower disk to fix the two conducting plates; the chip cup at the top of the screw is provided for inserting the Chip 975; the Conducting Wires 981, 982, 983, and 985 are connected to the chip, with the other end of the conducting wires connected to the two conducting plates; the Silicone 92 is filled into the Semi-round Lamp Housing 91 to form an integrated light-emitting device.

The chip cup screw of the Light-emitting Device 9 is then inserted into the Holes 71 of the I-shaped Frame Plate 7; the bent Vertical Conducting Plates 96 and 966 on the two sides are aligned simultaneously and pass through Rectangle Openings 72 and 722 so that the Holes 962 of the conducting plates cover the two Conducting Wires 6; the hollow rectangle covers of the Stop Pieces 5 combine the ends of the conducting plates; the Semi-round Holes 56 on the two sides of the stop pieces clamp the conducting wires for stable power supply; the female thread of the Radiating Cap 2 is used to lock the male thread of the chip cup screw; the equally spaced LED lights are inserted into the two sides of the I-shaped frame plate by means of Plates 82 of the Frames 81 and 811; the I-shaped frame plate is locked with Screw A to present a suspendable structure; the chip cup screw transfers the heat of the lighting chip to the Radiating Fins 21 inside the radiating camp to diffuse the heat and reduce the temperature rapidly and extend the service life.

Through the above structure, the chip cup screw is packaged to the lower disk so that the two conducting plates, the upper disk, the chips and the conducting wires are integrated in order; the concave ring of the upper disk is provided for filling of silicone to fasten and protect the chip; the chip cup screw is inserted into the holes; the conducting plates on the two sides of the plate pass through the rectangle opening and the semi-round hole fastens the two conducting wires and the corresponding lights of the top pieces; the radiating cap locked by the chip cup screw transfers the heat of the chip directly to the radiating fins to diffuse the heat rapidly and effectively.

I claim:

1. A semi-conductor light, comprising radiating caps, two plates, a plurality of stop pieces, two conducting wires, one I-shaped frame plate, two positioning brackets and light-emitting devices, wherein:
A radiating cap being a conical round made of radiating material, inside which are equally spaced radiating fins, the said conical diameter having a screw tube at the top, the said screw tube having an internal female thread;
Two plates each being a square-plate, the surface of which are provided with two holes near the bottom;
A plurality of stop pieces being a hollow rectangle cover, on the two sides of which is a semi-round hole;
Two conducting wires, being two conducting wires with two ends threaded through the holes of the plates;
An I-shaped frame plate, being an I-shaped long strip plate having equally spaced holes on its surfaces, the holes having rectangle openings placed nearby oppositely and the two ends are provided for the two plates;
Two positioning brackets being two L-shaped frames having bent vertical plates in the lower part for locking the two ends of the I-shaped frame plate, the said two frames being welded with a joining plate at the top for locking to the ceiling surface;
The light-emitting device, comprising:
A semi-round lamp housing, being a transparent semi-round lamp housing;
A transparent silicone placed at the bottom of the said semi-round lamp;
An upper disk having a concave ring at the disk surface for the clamping and positioning of the ring seat of the lamp housing, the center of the said disk surface having an axial hole, the radial surface of the said concave ring having four equally spaced elliptical holes;
Two conducting plates, being two conducting plates with the semi-round shape in the front, the bent vertical ends in the middle of the said two plates having semi-round holes for fastening the conducting wires and the assembly of the stop pieces;
A lower disk, being an integrated projected hollow bushing in the disk, the ring surface of the said disk having corresponding semi-round concave groove of the corresponding conducting plates and the concave groove of the Y-shaped plate for the insertion of the two conducting plates so that the axial hole of the upper disk is fitted and integrated;
A semi-conductor chip, the upper part of the said chip is provided for connecting the one end of the conducting wires, the other end of the conducting wires pass through the four elliptical holes of the upper disk and jump the semi-round conducting plates of the two conducting plates for the introduction of the power supply;
A chip cup, being a heat transfer screw having a gasket ring and a pipe shaft at the top so that the pipe shaft passes through the hollow shaft bushing of the pipe shaft for positioning, the male thread of the lower screw fits the screw tube of the radiating cap, the top of the said screw having a chip cup for the seating of the chip;
Through the above structure, the chip cup screw is packaged to the lower disk so that the two conducting plates, the upper disk, the chips, and the conducting wires are integrated in order; the concave ring of the upper disk is provided for filling of silicone and the lamp housing to fasten and protect the chip; the chip cup screw is inserted into the holes; the conducting plates on the two sides of the plate pass through the rectangle opening and the semi-round hole fastens the two conducting wires and the corresponding lights of the stop pieces; the radiating cap locked by the chip cup screw transfers the heat of the chip directly to the radiating fins to diffuse the heat rapidly and effectively.
